(19) United States
(12) Patent Application Publication
(10) Pub. No.: US 2005/0260513 A1
(43) Pub. Date: Nov. 24, 2005

(54) Round powder particle

(75) Inventor: Michael Bayer, Thierhaupten (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 11/132,820

(22) Filed: May 19, 2005

(30) Foreign Application Priority Data
May 19, 2004 (DE) 10 2004 024 700.5

(51) Int. Cl. G03G 9/08

(52) U.S. Cl. 430/108.1; 430/110.3; 430/137.1

(57) ABSTRACT

The present invention relates to a toner powder wherein the particles have a round shape, to a process for its production, and to its use.

The present invention is described in the German priority application No. 102004024700.5, filed 19 May 2004, which is hereby incorporated by reference as is fully disclosed herein.

The present invention relates to a toner powder, to a process for its production, and to its use.

For the contactless printing of surfaces such as paper, plastic or metal use is made of pulverulent printing media, known as toners, which are transferred by electrophotographic techniques to the substrates to be printed, and subsequently are fixed, generally by thermal means.

Said toners are composed customarily of a resin component, a colorant, usually a pigment, and functional additives which assist processing.

One customary method of producing such powders is the thermoplastic mixing of the components at temperatures above the resin's melting point, with subsequent mechanical comminution and fractionation to the desired particle size.

As a consequence of the process these powders have an irregular particle shape, which is deleterious for the important processing properties of free flow and uniform distribution of the powders on the substrate to be printed.

The abovementioned process sequence is described for example in EP-A-0 772 093.

In order to produce powders with better flow and a round particle shape, processes are proposed which are united under the rubric of chemically prepared toners (called CPTs).

These toner powders are prepared using—according to manufacturer—methods of emulsion polymerization, of microencapsulation or of suspension polymerization.

In actual fact these processes yield round particles which subsequently are first separated from the liquid polymerization medium by filtration and drying and are then classified into the desired particle size.

A disadvantage of these CPT processes, however, is that the oversize and undersize particle fractions which remain cannot be recycled or otherwise used. This increases the costs of toner production.

An object which therefore existed was to provide a powder whose particle shape is round and which does not exhibit the disadvantages referred to.

Surprisingly it has been found that powders with a round particle shape for contactless printing of surfaces can be produced by subjecting polyolefins polymerized in the presence of metallocene catalysts first to spraying by means of a thermal spraying process above their melting point, to form droplets, which are then solidified in a gas atmosphere to form round particles.

It has additionally been found that the oversize and undersize fractions of the classified powder can be remelted and can be processed again—and hence without losses—to give round particles of the desired fraction.

The present invention accordingly provides a toner powder whose particles have a round shape.

The diameter of the powder particles is preferably 1 to 50 μm, more preferably 5 to 20 μm, and very preferably 8 to 15 μm.

The toner powder preferably comprises at least one metallocene wax.

The toner powder preferably comprises at least one metallocene wax and at least one pigment.

More preferably the toner powder comprises at least one metallocene wax, at least one pigment, and at least one additive.

The additive is preferably a charge control agent.

The metallocene waxes are preferably polyolefin waxes, more preferably homopolymers of ethylene or propylene or copolymers of ethylene or propylene with one another or with one or more 1-olefins having 4 to 50, preferably 4 to 20, carbon atoms.

The metallocene waxes are preferably polyolefin waxes having a dropping point of between 90 and 160° C., preferably between 100 and 155° C., a melt viscosity at 140° C. of between 10 and 10 000 mPa.s, preferably between 50 and 5000 mPa.s, and a density at 20° C. of between 0.89 and 0.96 cm³/g, preferably between 0.91 and 0.94 cm³/g.

The metallocene waxes preferably have a polar modification.

The invention also relates to a process for producing the toner powder of the invention which comprises melting a metallocene wax and then subjecting it first to spraying by means of a thermal spraying process above the melting point of the metallocene wax, to form droplets, and then solidifying the droplets in a cooling gas atmosphere to form round particles.

The gas of the cooling gas atmosphere is preferably air, nitrogen or mixtures thereof.

It is preferred to use, additionally, at least one pigment together with the metallocene wax.

It is preferred to use, additionally, at least one pigment and/or at least one additive, in particular a charge control agent, together with the metallocene wax.

The round particles thus obtained are preferably classified by a fractionation process.

The oversize and undersize fractions of the classified powder are preferably remelted and recycled to the process.

The invention also provides for the use of the toner powder of the invention for producing printed products.

The invention also provides for the use of the toner powder of the invention in or for digital printing processes.

The invention also provides for the use of the toner powder of the invention in or for photocopiers and printing machines.

The present invention accordingly provides for the use of a polyolefin which has a dropping point of between 40 and 160° C., a melt viscosity of 2 to 20 000 mpa.s, and a needle penetration number of 1 to 50.

The dropping point is determined according to DIN 51801, version of 1980-12, the melt viscosity according to DIN 53018-1 and -2, version of 1976-03, and the needle penetration number according to DIN 51579, version of 1965-05.

Appropriate polyolefin waxes include homopolymers of ethylene or propylene or copolymers of ethylene or propylene with one another or with one or more 1-olefins. 1-Olefins used are linear or branched olefins having 4-18 carbon atoms, preferably 4-6 carbon atoms. Examples thereof are 1-butene, 1-hexene, 1-octene, and 1-octadecene, and additionally styrene. Preference is given to copolymers of ethylene with propene or 1-butene. The ethylene content of the copolymers is 70%-99.9% by weight, preferably 80%-99% by weight.

Metallocene catalysts for preparing the polyolefin waxes are chiral or nonchiral transition metal compounds of the formula M¹Lₓ. The transition metal compound M¹Lₓ contains at least one central metal atom M¹ attached to which there is at least one π ligand, a cyclopentadienyl ligand for example. In addition it is possible for substituents, such as halogen, alkyl, alkoxy or aryl groups, for example, to be attached to the central metal atom M¹. M¹ is preferably an element from main groups III, IV, V or VI of the Periodic Table of the Elements, such as Ti, Zr or Hf. Cyclopentadienyl ligand comprehends unsubstituted cyclopentadienyl radicals and substituted cyclopentadienyl radicals such as methylcyclopentadienyl, indenyl, 2-methylindenyl, 2-methyl-4-phenylindenyl, tetrahydroindenyl or octahydrofluorenyl radicals. The π ligands may be bridged or unbridged, and both single and multiple bridges, including those via ring systems, are possible. The metallocene identity also embraces compounds containing more than one metallocene fragment, so-called polynuclear metallocenes. These may have any desired substitution patterns and bridging variants. The individual metallocene fragments of such polynuclear metallocenes may be of the same kind or else different from one another. Examples of such polynuclear metallocenes are described in EP-A-0 632 063 for example.

Examples of general structural formulae of metallocenes and also of their activation with a cocatalyst are given in EP-A-0 571 882 among others.

Also suitable are polar-modified metallocene waxes. The polar modification of these polyolefin waxes may take place by oxidation with oxygen or oxygen-containing gases above or below the melting point. Preferably the wax is oxidized in the liquid melt state at temperatures between the melting point of the wax and 200° C. by introduction of oxygen or oxygen-containing gases, preferably air. The oxidation-modified waxes have acid numbers of between 0.1 and 100, preferably 1 and 30, mg KOH/g, melt viscosities, measured at 170° C., of 5 to 10 000 mpa.s, preferably 20 to 5000 mPa.s, and softening points of 80 to 160° C. Also included are derivatives of such oxidates as may be prepared, for instance, by esterifying the oxidates with monohydric or polyhydric, aliphatic or aromatic alcohols, e.g., ethanol, propanols, butanols, ethanediol, butanediols, glycerol, trimethylolpropane, pentaerythritol or benzyl alcohol. In the event of partial esters being present, a further possibility is that of further derivatization of such esters by means, for instance, of their esterification with acid components such as acrylic acid or methacrylic acid.

A further possibility of polar modification lies in the reaction of a polyolefin wax with α,β-unsaturated carboxylic acids or derivatives thereof, in the presence where appropriate of a free-radical initiator. Examples that may be mentioned of α,β-unsaturated carboxylic acids include acrylic acid, methacrylic acid, crotonic acid, and maleic acid. Examples that may be mentioned of derivatives of α,β-unsaturated carboxylic acids include their esters or amides or anhydrides, examples being acrylic acid alkyl esters, acrylic acid amides, monoesters or diesters of maleic acid, maleic anhydride, or amides of maleic acid, such as maleimide, for example, or N-alkyl-substituted maleimides. Mixtures of these compounds, too, can be used. Preference is given to maleic acid and its derivatives, with particular preference going to maleic anhydride. The α,β-unsaturated carboxylic acids and/or derivatives thereof are employed in an amount, based on polyolefin wax used, of 0.1%-20% by weight. The preparation of polar reaction products of this kind, produced free-radically, is described for example in EP 0941257. Those prepared by reacting polyolefin waxes with α,β-unsaturated carboxylic acids and their derivatives have melt viscosities, measured at 170° C., of 5 to 10 000 mPa.s, preferably 10 to 5000 mPa.s, hydrolysis numbers of 0.1 to 100 mg KOH/g, preferably 2 to 80 mg KOH/g, and softening points of 80 to 160° C., preferably 100 to 155° C.

The invention further embraces the use of wax products prepared by free-radical reaction of polyolefin waxes with styrene in an amount of 0.1%-30% by weight, based on the polyolefin wax used.

A further possibility is to combine the aforementioned modification methods: for example, by first reacting the polyolefin wax with α,β-unsaturated carboxylic acids or derivatives thereof and then oxidizing the product.

The powder of the invention may comprise at least one further wax. The latter preferably comprises polyolefins prepared using Ziegler catalysts; natural waxes such as candelilla waxes, beeswax or carnauba waxes; or else montan waxes and derivatives thereof, waxes synthesized by Fischer-Tropsch processes, including those in polar-modified form, or else polysiloxane-modified alkyls.

The powder of the invention may further comprise resins of natural origin or resins prepared synthetically. Resins such as may be present in the powder of the invention are hydrocarbon resins based on abietic acid or based on coumarone-indene. Synthetic resins are based on ethylene-vinyl acetate copolymer, styrene-acrylate, polyester or polysiloxanes.

The resins useful in accordance with the invention have a softening point of 30-150° C.

Of particular suitability as pigments for the purposes of the present invention are inclusion pigments such as are used for ceramic colors.

Useful pigment is also a finely divided organic or inorganic pigment and/or an organic dye or a mixture of different organic and/or inorganic pigments and/or organic dyes. The pigments may be used either in the form of dry powders or of water-moist presscakes.

Suitable organic pigments include monoazo, disazo, laked azo, β-naphthol, Naphtol AS, benzimidazolone, disazo condensation, azo metal complex and polycyclic pigments, such as, for example, phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline and diketopyrrolopyrrole pigments or carbon blacks.

Also suitable are surface-modified pigments whose surface has been altered by chemical operations such as sulfonation or diazotization, for example, and has been provided with functional groups, possibly charge-carrying groups, or polymer chains (known in the literature as self-dispersing or graft pigments).

Examples of suitable inorganic pigments include titanium dioxides, zinc sulfides, iron oxides, chromium oxides, ultramarine, nickel or chromium antimony titanium oxides, cobalt oxides, and bismuth vanadates.

Suitable organic dyes include acid dyes, direct dyes, sulfur dyes and their leuco form, metal complex dyes, or reactive dyes; in the case of the reactive dyes, dyes reacted with nucleophiles can also be used.

Of the abovementioned organic pigments, those which are suitable are the pigments whose lighffastness, assessed on a blue scale, is given a rating of more than 5, in particular more than 6. Moreover, the pigments used for producing the preparations ought to be very finely divided, with preferably 95% and more preferably 99% of the pigment particles possessing a size ≦500 nm. The average particle size ideally has a value <150 nm. Depending on the pigment used it is possible for the morphology of the pigment particles to differ very greatly, and, accordingly, the viscosity behavior of the pigment preparations may also be very different as a function of the particle morphology. Preference is given to pure or subsequently purified pigments with as few as possible organic or inorganic impurities.

As an exemplary selection of organic pigments mention may be made here of carbon black pigments, such as gas blacks or furnace blacks, for example; monoazo and disazo pigments, especially the Colour Index pigments Pigment Yellow 1, Pigment Yellow 3, Pigment Yellow 12, Pigment Yellow 13, Pigment Yellow 14, Yellow 16, Pigment Yellow 17, Yellow 73, Pigment Yellow 74, Pigment Yellow 81, Pigment Yellow 83, Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34 or Pigment Brown 41; β-naphthol and Naphtol AS pigments, particularly the Colour Index pigments Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 256, Pigment Orange 5, Pigment Orange 38 or Pigment Brown 1; laked azo and metal complex pigments, particularly the Colour Index pigments Pigment Red 48:2, Pigment Red 48:3, Pigment Red 48:4, Pigment Red 57:1, Pigment Red 257, Pigment Orange 68 or Pigment Orange 70; benzimidazoline pigments, particularly the Colour Index pigments Pigment Yellow 120, Pigment Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72 or Pigment Brown 25; isoindolinone and isoindoline pigments, particularly the Colour Index pigments Pigment Yellow 139 or Pigment Yellow 173; phthalocyanine pigments, particularly the Colour Index pigments Pigment Blue 15, Pigment Blue 15:1, Pigment Blue 15:2, Pigment Blue 15:3, Pigment Blue 15:4, Pigment Blue 16, Pigment Green 7 or Pigment Green 36; anthanthrone, anthraquinone, quinacridone, dioxazine, indanthrone, perylene, perinone and thioindigo pigments, particularly the Colour Index pigments Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23 or Pigment Orange 43; triarylcarbonium pigments, particularly the Colour Index pigments Pigment Red 169, Pigment Blue 56 or Pigment Blue 61; and diketopyrrolopyrrole pigments, particularly the Colour Index pigment Pigment Red 254.

As a selection of organic dyes mention may be made of the Colour Index dyes Acid Yellow 17, Acid Yellow 23, Direct Yellow 86, Direct Yellow 98, Direct Yellow 132, Reactive Yellow 37, Acid Red 52, Acid Red 289, Reactive Red 23, Reactive Red 180, Acid Blue 9 and Direct Blue 199 and of the reactive dyes that have been reacted with nucleophiles.

1. A toner powder whose comprising powder particles, wherein the powder particles have a round shape.

2. The toner powder as claimed in claim 1, wherein the diameter of the powder particles is 1 to 50 μm.

3. The toner powder as claimed in claim 1, further comprising at least one metallocene wax.

4. The toner powder as claimed in claim 1, further comprising at least one metallocene wax and at least one pigment.

5. The toner powder as claimed in claim 1, further comprising at least one metallocene wax, at least one pigment, and at least one additive.

6. The toner powder as claimed in claim 4, wherein the at least one additive is a charge control agent.

7. The toner powder as claimed in claim 2, wherein the at least one metallocene wax is a polyolefin wax.

8. The toner powder as claimed in claim 2, wherein the at least one metallocene wax is a polyolefin wax having a dropping point of between 90 and 160° C., a melt viscosity at 140° C. of between 10 and 10 000 mPa.s, and a density at 20° C. of between 0.89 and 0.96 cm³/g.

9. The toner powder as claimed in claim 2, wherein the at least one metallocene wax has a polar modification.

10. A process for producing a toner powder comprising the steps of melting a composition, subjecting the composition to spraying by a thermal spraying process at a temperature above the melting point of the composition to form droplets, and solidifying the droplets in a cooling gas atmosphere to form round particles, wherein the composition includes at least one metallocene wax.

11. The process as claimed in claim 10, wherein the gas of the cooling gas atmosphere is air, nitrogen or a mixture thereof.

12. The process as claimed in claim 10, wherein the composition further comprises at least one pigment.

13. The process as claimed in claim 10, wherein the composition includes at least one of at least one pigment and at least one additive.

14. The process as claimed in claim 10, further comprising the step of fractionating the round particles.

15. The process as claimed in claim 14, wherein the fractionating step separates oversize and undersize particles and the process further comprises melting the oversize and undersize particles and recycling the oversize and undersize particles.

16. A printed product printed with a toner powder as claimed in claim 1.

17. A digitally printed product printed with a toner powder as claimed in claim 1.

18. A photocopier or printing machine product produced with a toner powder as claimed in claim 1.

19. The toner powder as claimed in claim 1, wherein the diameter of the powder particles is 5 to 20 μm.

20. The toner powder as claimed in claim 1, wherein the diameter of the powder particles is 8 to 15 μm.

21. The toner powder as claimed in claim 7, wherein the polyolefin wax is a homopolymer of ethylene or propylene or a copolymer of ethylene or propylene with one another or with one or more 1-olefins having 4 to 50.

22. The toner powder as claimed in claim 7, wherein the polyolefin wax is a homopolymer of ethylene or propylene or a copolymer of ethylene or propylene with one another or with one or more 1-olefins having 4 to 20.

23. The toner powder as claimed in claim 2, wherein the at least one metallocene wax is a polyolefin wax having a dropping point of between 100 and 155° C., a melt viscosity at 140° C. of between 50 and 5000 mPa.s, and a density at 20° C. of between 0.91 and 0.94 cm³/g.

24. The process as claimed in claim 13, wherein the at least one additive is a charge control agent.

25. A toner powder made in accordance with the process of claim 10.

26. A toner composition for an image producing apparatus comprising a toner powder as claimed in claim 1, wherein the image producing apparatus is selected from the group consisting of digital printing apparatus, printing machines and photocopiers.
